(19) United States
(12) Patent Application Publication
(10) Pub. No.: US 2016/0297987 A1
(43) Pub. Date: Oct. 13, 2016

(54) SILICONE-MODIFIED POLYESTER COATING

(71) Applicant: Valspar Sourcing, Inc., Minneapolis, MN (US)

(72) Inventors: Gregory B. Hayes, Apple Valley, MN (US); Thomas J. Mainyk, Greenfield, MN (US); Melody Taylor, Bowling Green, KY (US); Shu Pei Li, Toronto (CA); D. Michelle Lieu, Lakeville, MN (US)

(73) Assignee: Valspar Sourcing, Inc., Minneapolis, MN (US)

(21) Appl. No.: 15/176,949

(22) Filed: Jun. 8, 2016

Related U.S. Application Data
(63) Continuation of application No. PCT/US2014/070096, filed on Dec. 12, 2014.
(60) Provisional application No. 61/918,285, filed on Dec. 19, 2013.
(60) Provisional application No. 61/917,147, filed on Dec. 17, 2013.

(51) Int. Cl. C09D 167/00

(52) U.S. Cl. CPC C09D 167/00

(57) ABSTRACT

The present invention provides a coating composition having excellent weatherability and durability. The coating composition includes a binder system comprising a durable polyester resin and a siliconized polyester resin having up to about 45 wt % silicone content. Coated articles with the coating composition applied to at least a portion of a surface thereof are also provided.

### CROSS-REFERENCE TO RELATED APPLICATIONS

This application is a continuation of pending International Application No. PCT/US2014/070096, filed 12 Dec. 2014, which claims the benefit of U.S. Provisional Application No. 61/918,285 filed on 19 Dec. 2013 and U.S. Provisional Application No. 61/917,147 filed on 17 Dec. 2013, each of which is incorporated herein by reference in its entirety.

### BACKGROUND

Polymer coating compositions are routinely applied to substrates, especially metal substrates. Such coatings are used for a variety of reasons, including, for example, to protect the substrate from degradation, to beautify the substrate (e.g., to provide color, brightness, etc.), and/or to reflect light.

Many such polymer coating compositions are applied on planar substrates (e.g., using coil coating processes) that are subsequently formed into finished articles, including articles used as exterior building materials. In general, for a coating composition to be used as an exterior coil coating, the composition must demonstrate long-term outdoor weathering, durability and improved wear resistance. The coating must also maintain a suitable aesthetic appearance (gloss, color, and the like) over prolonged periods of exposure to exterior conditions, including sunlight, humidity, rain and the like.

Thermosetting silicone-modified polyester coatings can be used for exterior coil coating applications. Conventionally, however, such coatings, while initially weatherable and durable, demonstrate significant decrease in weatherability and durability after prolonged periods of exposure to natural weather conditions. Moreover, such coatings may demonstrate significant processing difficulties, such as increased cure time, reduced line speed capability, or tendency toward oven contamination.

Accordingly, there is a continuing need for thermosetting silicone-modified coil coatings that provide reduced cure dwell times and increased line speed capability, while having equal or improved weathering capabilities.

### SUMMARY

In one embodiment, the present description provides a cured coating formed from a thermosetting coating composition that forms a weatherable exterior coating when cured. The coating composition includes a binder system that comprises at least a first polyester resin and a second polyester resin having up to about 45% silicone content by weight of the solid polymer. The coating composition may include other ingredients, including one or more of the following: (i) a crosslinking agent, (ii) a catalyst, (iii) pigments, and/or (iv) a flow agent. The composition forms a weatherable exterior coating with a 60° gloss rating of about 5 to 90, and does not show an appreciable change in color or appearance after uv or natural sunlight exposure equivalent to several years.

In another embodiment, the present description provides coated articles, typically metal substrates, having disposed on at least a portion of the substrate a cured coating formed from the coating composition described herein.

In yet another embodiment, the present invention provides a method of producing an article from a metal substrate, wherein the substrate has, disposed on at least a portion of its surface, a cured coating formed from the coating composition described herein.

### BRIEF DESCRIPTION OF FIGURES

FIG. 1 shows a series of SEM images for the coating compositions described herein, demonstrating different quantities of silicone, titanium, zinc, and the like.

### DEFINITIONS

Unless otherwise specified, the following terms as used herein have the meanings provided below.

Substitution is anticipated on the organic groups of the polyesters and other polymeric resins used in the coating compositions described herein. As a means of simplifying the discussion and recitation of certain terminology used throughout this application, the terms “group” and “moiety” are used to differentiate between chemical species that allow for substitution or that may be substituted and those that do not allow or may not be so substituted. Thus, when the term “group” is used to describe a chemical substituent, the described chemical material includes the unsubstituted group and that group with O, N, Si, or S atoms, for example, in the chain (as in an alkoxy group) as well as carbonyl groups or other conventional substitution. Where the term “moiety” is used to describe a chemical compound or substituent, only an unsubstituted chemical material is intended to be included. For example, the phrase “alkyl group” is intended to include not only pure open chain saturated hydrocarbon alkyl substituents, such as methyl, ethyl, propyl, t-butyl, and the like, but also alkyl substituents bearing further substituents known in the art, such as hydroxy, alkoxy, alkylsulfonyl, halogen atoms, cyano, nitro, amino, carboxyl, etc. Thus, “alkyl group” includes ether groups, haloalkyls, nitroalkyls, carboxyalkyls, hydroxyalkyls, sulfoalkyls, etc. On the other hand, the phrase “alkyl moiety” is limited to the inclusion of only pure open chain saturated hydrocarbon alkyl substituents, such as methyl, ethyl, propyl, t-butyl, and the like. The term “hydrocarbyl moiety” refers to unsubstituted organic moieties containing only hydrogen and carbon. As used herein, the term “group” is intended to be a recitation of both the particular moiety, as well as a recitation of the broader class of substituted and unsubstituted structures that includes the moiety.

The term “crosslinker” refers to a molecule capable of forming a covalent linkage between polymers or between two different regions of the same polymer.

The term “on”, when used in the context of a coating applied on a surface or substrate, includes both coatings applied directly or indirectly to the surface or substrate. Thus, for example, a coating applied to a primer layer overlying a substrate constitutes a coating applied on the substrate.

Unless otherwise indicated, the term “polymer” includes both homopolymers and copolymers (i.e., polymers of two or more different monomers). Similarly, unless otherwise indicated, the use of a term designating a polymer class such as, for example, “polyester” is intended to include both homopolymers and copolymers (e.g., polyester-urethane polymers).

The term “unsaturation” when used in the context of a compound refers to a compound that includes at least one double bond that is not present in an aromatic ring.

As used herein, the term “silicone” refers to polymerized siloxanes or polysiloxanes, which are mixed inorganic-organic polymers with the general structural formula [R₂SiO]n, where R is substituted or unsubstituted C1-C12 alkyl, C1-C12 alkoxy, C6-C10 aryl, and the like. As used herein, the silicone is a hydroxy-functional or alkoxy-functional polysiloxane.

The term “durable,” as used herein, refers to a coating that resists or withstands prolonged exposure to uv radiation.

As used herein, the term “weatherable” means a coating that can resist or withstand the effects of prolonged exposure to the weather (i.e. sunlight, wind, humidity, precipitation, and the like). The term is used interchangeably with “weathering.” Although the terms are not coextensive, a durable coating is likely to be weatherable and vice-versa.

The term “comprises” and variations thereof do not have a limiting meaning where these terms appear in the description and claims.

The terms “preferred” and “preferably” refer to embodiments of the invention that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the invention.

As used herein, “a,” “an,” “the,” “at least one,” and “one or more” are used interchangeably. Thus, for example, a coating composition that comprises “an” additive can be interpreted to mean that the coating composition includes “one or more” additives.

Also herein, the recitations of numerical ranges by endpoints include all numbers subsumed within that range (e.g., 1 to 5 includes 1, 1.5, 2, 2.75, 3, 3.80, 4, 5, etc.). Furthermore, disclosure of a range includes disclosure of all subranges included within the broader range (e.g., 1 to 5 discloses 1 to 4, 1.5 to 4.5, 1 to 2, etc.).

### DETAILED DESCRIPTION

In one embodiment, the present description provides a cured coating formed from a thermosetting coating composition that exhibits excellent durability and weatherability when used as an exterior coating or as a coating on exterior building materials. The coating composition typically comprises a binder system, a crosslinking agent, a catalyst, a flow agent, one or more pigments, and an optional liquid carrier. The binder system preferably includes a first polyester resin that is durable, and a second polyester resin that has a silicone backbone including up to about 45 wt % silicone. Preferably, the coating composition includes at least a film-forming amount of the binder system. Although coating compositions including a liquid carrier are presently preferred, it is contemplated that the composition described herein may have utility in other coating application techniques such as, for example, powder coating, extrusion, or lamination.

In one embodiment, the binder system includes a first polyester resin, preferably a durable polyester resin. Suitable polyesters include, for example, resins formed by reaction of compounds having reactive functional groups such as, for example, compounds with hydroxyl, carboxyl, anhydride, acyl, or ester functional groups. Hydroxyl functional groups are known to react, under proper conditions, with acid, anhydride, acyl or ester functional groups to form a polyester linkage. Suitable compounds for use in forming the polyester resin include mono-, di-, and multi-functional compounds. Di-functional compounds are presently preferred. Suitable compounds include compounds having reactive functional groups of a single type (e.g., mono-, di-, or poly-functional alcohols or mono-, di-, or poly-functional acids) as well as compounds having two or more different types of functional groups (e.g., a compound having both an anhydride and an acid group, or a compound having both an alcohol and an acid group, etc.).

Conventionally, durable polyester resins are formed by the condensation of dicarboxylic acids or anhydrides with dihydroxy-functional compounds or diols. Suitable acids include, without limitation, isophthalic acid, terephthalic acid, phthalic anhydride, maleic anhydride, and the like. Suitable diols include, without limitation, neopentyl glycol, 2-methyl-1,3-propanediol, 2,2,4-trimethyl-1,3-pentanediol, 1,6-hexanediol, and the like. In an aspect, the first polyester resin is a durable polyester resin, preferably made by the reaction of neopentyl glycol with isophthalic acid. The amount of durable polyester in the binder system is preferably about 40 to 80 wt %, more preferably about 50 to 75 wt %, based on the total weight of the binder system.

In an embodiment, the binder system includes a second polyester resin, preferably a silicone-modified or siliconized polyester resin. Suitable siliconized polyesters include those formed by the reaction of silicone-functional compounds with compounds having other reactive functional groups such as, for example, compounds with hydroxyl, carboxyl, anhydride, acyl, or ester functional groups. Suitable silicone-functional compounds include, for example, polymerized siloxanes (also known as organo-siloxanes or organic polysiloxanes) of the general formula [R₂SiO]ₙ, where R is typically C1-C12 alkyl (preferably methyl or ethyl), C1-C12 alkoxy (preferably methoxy or ethoxy), aryl (preferably phenyl), and the like. In an aspect, the polymerized siloxanes include reactive functional groups, such as hydroxyl groups, alkoxy groups, silanol groups, and the like.

Conventionally, siliconized polyesters are made by reaction of reactive organo-siloxanes or polymerized siloxanes with polyester resins having reactive functional groups. Specifically, siliconized polyesters are typically prepared by the reaction of a hydroxy-functional polyester with a hydroxy-functional or alkoxy-functional organic polysiloxane. The hydroxy-functional polyester is typically a highly branched low molecular weight polyester, or a linear high molecular weight polyester. The siloxane and polyester are combined in approximately stoichiometric amounts in a condensation reaction to provide the siliconized polyester.

Without limiting to theory, it is believed that the reaction of the siloxane and polyester is a condensation reaction, where the hydroxyl functional groups of the polymerized siloxane backbone react by self-condensation, producing a semi-interpenetrating siloxane network. In contrast, the siliconized polyester described herein is prepared from a co-condensation reaction between hydroxy-functional silicone, i.e. a hydroxy-functional polymerized siloxane, for example, with a molecular weight (Mₙ) of about less than about 10,000 (M_{w} of less than about 15,000), preferably 500 to 3000, and a reactive hydroxy-functional compound (i.e. a diol such as, for example, neopentyl glycol, 2-methyl-1,3-propanediol, 2,2,4-trimethyl-1,3-pentanediol, 1,6-hexanediol, and the like), producing a polymer with silyl ether functionality rather than silanol or siloxane functionality. The formed polymer is then esterified by reaction with an acid-functional compound, including, without limitation, isophthalic acid, terephthalic acid, phthalic anhydride, maleic anhydride, and the like, forming a siliconized polyester. The preparation of the siliconized polyester is described in detail in Applicant's co-pending Application, filed even date herewith. The amount of siliconized polyester in the binder system is preferably about 5 to 60 wt %, more preferably about 10 to 55 wt %, based on the total weight of the binder system.

In an embodiment, the coating composition further includes a crosslinker or crosslinking agent. The crosslinker may be used to facilitate cure of the coating and to build desired physical properties. When present, the amount of crosslinker will vary depending upon a variety of factors, including, e.g., the intended end use and the type of crosslinker. Typically, one or more crosslinkers will be present in the coating composition in an amount greater than about 0.01 wt-%, more preferably from about 5 wt % to about 50 wt %, even more preferably from about 10 wt % to about 30 wt %, and most from about 15 wt % to about 20 wt %, based on total weight of resin solids.

Polyesters having hydroxyl groups are curable through the hydroxyl groups. Suitable hydroxyl-reactive crosslinking agents may include, for example, aminoplasts, which are typically oligomers that are the reaction products of aldehydes, particularly formaldehyde; amino- or amido-group-carrying substances exemplified by melamine, urea, dicyandiamide, benzoguanamine and glycoluril; blocked isocyanates, or a combination thereof.

Suitable crosslinkers include aminoplasts, which are modified with alkanols having from one to four carbon atoms. It is suitable in many instances to employ precursors of aminoplasts such as hexamethylol melamine, dimethylol urea, hexamethoxymethyl melamine, and the etherified forms of the others. Thus, a wide variety of commercially available aminoplasts and their precursors can be used. Suitable commercial amino crosslinking agents include those sold by Cytek under the tradename CYMEL (e.g., CYMEL 301, CYMEL 303, and CYMEL 385 alkylated melamine-formaldehyde resins, or mixtures of such resins, are useful) or by Solutia under the tradename RESIMENE.

Suitable crosslinkers may also include blocked isocyanates, such as, for example, as described in U.S. Pat. No. 5,246,557. Blocked isocyanates are isocyanates in which the isocyanate groups have reacted with a protecting or blocking agent to form a derivative that will dissociate on heating to remove the protecting or blocking agent and release the reactive isocyanate group. Some examples of suitable blocking agents for polyisocyanates include aliphatic, cycloaliphatic or aralkyl monohydric alcohols, hydroxylamines and ketoximes. Presently preferred blocked polyisocyanates dissociate at temperatures of around 160° C. The presence of a catalyst is preferred to increase the rate of reaction between the liberated polyisocyanate and the active hydrogen-containing compound (e.g., a hydroxyl-functional polyester). The catalyst can be any suitable catalyst such as, for example, dibutyl tin dilaurate or triethylene diamine.

Suitable crosslinkers also include unblocked isocyanates. Unblocked isocyanates are difunctional or polyfunctional isocyanates with free isocyanate groups attached to aliphatic, cycloaliphatic, aryl, araliphatic and/or aromatic moieties. Examples include, without limitation, tetramethylene diisocyanate, hexamethylene diisocyanate, dodecamethylene diisocyanate, 1,4-diisocyanatocyclohexane, 3,5,5-trimethylcyclohexyl isocyanate, isophorone diisocyanate, and the like.

In some embodiments, an ultraviolet curing crosslinker or an electron-beam curing crosslinker may be suitable. Examples of suitable such crosslinkers may include 1,6-hexanediol diacrylate, 1,4-butanediol diacrylate, trimethylolpropane triacrylate, or mixtures thereof.

The coating composition described herein may be produced by conventional methods known to those of skill in the art. In an embodiment, the coating composition is prepared by use of a polymerization or processing aid, such as a catalyst, for example. Suitable processing aids include, without limitation, metal catalysts (e.g., stannous oxalate, stannous chloride, butylstannoic acid, dibutyl tin oxide, tetrabutyltitanate, or tetra butylzirconate), antioxidants (e.g., hydroquinone, monotertiarybutyl-hydroquinone, benzoquinone, 1,4-napthoquinone,2,5-diphenyl-p-benzoquinone, or p-tert butylpyrocatechol), unblocked and blocked acid catalysts (e.g., dinonylnaphthalene sulfonic acid, dinonylnaphthalene disulfonic acid, dodecyl benzene sulfonic acid, p-toluene sulfonic acid, phosphate esters, and mixtures or combinations thereof), and mixtures thereof. In a preferred aspect, the coating composition described herein is prepared using blocked p-toluene sulfonic acid (pTSA) as a catalyst. The amount of catalyst depends on the amount and nature of the reactants, but is up to about 5 wt %, preferably up to about 2 wt %, based on the total weight of resin solids.

The coating composition described herein is preferably made by blending the durable polyester resin with the siliconized polyester in the presence of a crosslinker. In an embodiment, the blending process is carried out in a liquid carrier, preferably a solvent or mixture of solvents, preferably a solvent or blend of solvents having a kauri butanol number (Kb) of about 50 or more. Suitable polar solvents include, for example, ketones (i.e. acetone, methyl ethyl ketone, cyclohexanone, and the like) esters (e.g., dialkyl esters (such as dimethyl ester, diisobutyl ester, and the like), long chain acetates, and the like), alcohols, chlorinated hydrocarbons, ester-ethers (e.g., glycol ether-esters, ethyl-3-ethoxypropionate, commercially available as EEP from Eastman, and the like), and combinations or mixtures thereof. In a preferred aspect, the polar solvent is a blend of ketone and ester, and is present in an amount of up to about 15 wt %, preferably about 5 wt % to 10 wt %, based on the total weight of the composition.

In an embodiment, the coating composition described herein includes one or more pigments. In an aspect, the pigment is preferably dispersed in the siliconized polyester component or in the melamine crosslinking agent. In another aspect, commercially available tint pastes may be used or combined with other pigments and incorporated into the coating composition to achieve the desired color or shade.

In an embodiment, the pigment may be dispersed in a blending polymer. Blending polymers include, for example, saturated polyesters, aliphatic polyurethane dispersions, and the like. In an aspect, the blending resin has a larger particle size and lower cost than either the first polyester resin or the siliconized polyester, and may be used as a partial replacement for the first polyester resin, or to influence specific coating properties such as, for example, flexibility.

In a preferred aspect, the pigment is dispersed in the siliconized polyester resin component, and is present in an amount up to about 60 wt %, preferably 20 to 50 wt %, based on the total weight of the composition.

In some embodiments, the pigment:binder weight ratio of the coating composition is preferably at least 0.02:1 to about 1.4:1. In certain embodiments, the pigment:binder weight ratio does not exceed about 1.4:1.

Other additives known in the art, may be included in the coating composition described herein. These additives include, without limitation, flatting agents, flow or viscosity modifiers, waxes and/or other binders that may be included or dispersed in the coating composition.

In an embodiment, the composition described herein includes one or more flatting agents. Suitable flatting agents include, for example, silica, silica-based materials, or other materials with particles known to provide easy dispensability. The amount of flatting agent depends on the desired gloss or reflectivity of the cured coating. As described herein, the coating composition includes up to about 6 wt %, preferably 1 to 5 wt %, of a silica or silica-based flatting agent, based on the total weight of resin solids in the composition.

In an embodiment, the coating composition described herein includes one or more flow modifiers. These flow or viscosity modifiers are typically used to aid in air release and improve the flow of the composition to allow for application to a substrate. Suitable flow modifiers include, for example, silicone-based compounds, metal salts of aromatic carboxylic acids (e.g., unsubstituted salicylic acid, unsubstituted naphthoic acid, alkyl- or aralkyl-substituted salicylic acid, alkyl- or aralkyl-substituted naphthoic acid, and the like), metal salts of aromatic hydroxy-functional carboxylic acids (e.g., 2-hydroxy-3-naphthoic acid, alkyl-substituted 2-hydroxy-3-naphthoic acid, and the like), and the like. In a preferred aspect, the flow modifier is a silicone-based compound and is present in an amount of about 1 wt %, preferably 0.01 to 0.5 wt %, based on the total weight of resin solids in the composition.

In an embodiment, the coating composition described herein includes one or more waxes. The wax is typically used to aid in handling of the coating composition prior to application, and may also be used to reduce or prevent abrasion of the cured coating. Suitable waxes include, for example, naturally occurring waxes (e.g., carnauba and the like), polymeric waxes (e.g., polyethylene-polyvinyl acetate wax, polyethylene glycol wax, and the like), etc. In a preferred aspect, the coating composition described herein includes a polymeric was, such as PTFE wax or polyethylene wax, and the wax is present in amount of up to about 15 wt %, preferably about 1.5 to 10 wt %, based on the total weight of resin solids in the composition.

The total amount of solids present in the coating composition described herein may vary depending upon a variety of factors including, for example, the desired method of application. For coil coating applications, the coating composition will typically include from about 30 to about 65 wt % of solids. In some embodiments, the coating composition may include as much as 80 wt % or more of solids.

Preferred cured coating compositions of the invention have excellent adhesion, hardness, flexibility, and abrasion resistance. In particular, the cured coating compositions described herein demonstrate equivalent or improved weathering capabilities relative to commercially available weatherable coatings, along with improved flow and leveling and decrease in cure time. The combined properties of improved flow and leveling, with decreased cure time, allow applicators to run lines more efficiently, thereby improving throughput. This combination of properties was also unexpected because, unlike conventional coating compositions made with siliconized components, the cured coating composition described herein does not experience a loss in weatherability over time.

In a conventional coating composition including a siliconized polymer resin system, the coating is believed to undergo a process of self-stratification, when silicone in the coating composition migrates to the surface of the coating during cure. The silicone at the surface erodes over time such that the coating is no longer weatherable and shows significant reduction in scratch resistance, wear performance, and durability. Moreover, the silicone at the surface may interact with other formulation components (crosslinking agents, pigments, and the like), resulting in a change in appearance over time. For example, TiO₂ pigment is often distributed through the coating in a non-homogenous manner which impacts the wear performance of the coating by driving up the coefficient of friction.

Surprisingly, the coating composition described herein provides a durable and weatherable coil coating for exterior use that does not demonstrate self-stratification or migration of silicone to the surface. Without limiting to theory, this is believed to be because the siliconized resin component of the composition is prepared by a process whereby the silicone content in the siliconized polyester is predominantly silyl ether groups rather than the silanol groups present in conventional siliconized polymer resins. This is believed to lead to a preponderance of free hydroxyl groups in the composition that promote crosslinking and thereby reduce the extent of stratification and/or interaction of the siliconized polyester with other components of the composition. Unexpectedly, the coating composition described herein produces significantly less of the oven contamination believed to result from evaporation of silicone during the curing process.

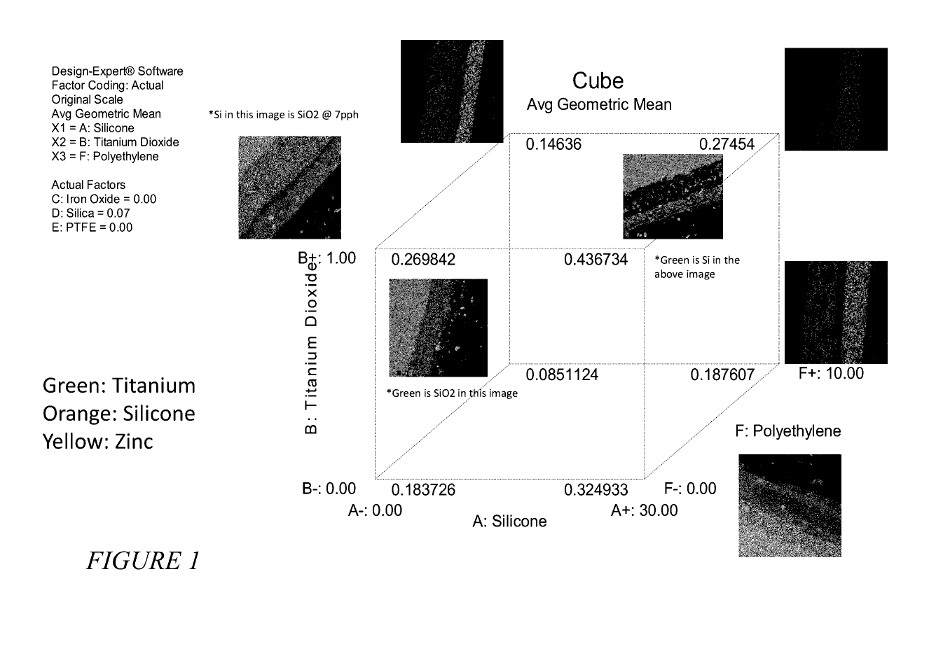

In addition, by controlling the synthesis of the resin and driving the co-condensation with the polymer segment rather than self-condensation between silanol groups, a more homogenous finished film is produced. Some domains of pigment (such as TiO2, for example) will be present within the siloxane segments of the siliconized polymer. By ensuring that these segments are fully polymerized and incorporated into the polyol backbone, the distribution of TiO2 can be regulated to be more uniform and homogenous. The enhanced weathering performance of the coating would be maintained and result in a finished film with overall greater durability, in terms of both weathering resistance and damage resistance (wear resistance). This can be seen in the SEM images shown in FIG. 1.

Accordingly, in an embodiment, and in contrast to conventional siliconized polyester coatings, the coating described herein shows durability, wear resistance and weatherability comparable or even superior to commercially available siliconized polyester exterior coil coatings when exposed outdoors for extended timeframes.

The coating composition described herein, when applied to a substrate and cured, preferably demonstrates durability and weatherability comparable to commercially available coil coatings. The weatherability of a cured coating may be assessed by monitoring changes in the appearance of the coated substrate over time. For example, a weatherable coating as described herein will demonstrate specular gloss (as measured by a handheld gloss meter) of from about to 5 about 90, more preferably from about 10 to about 50, and most preferably from about 20 to about 40 at a 60° angle.

In an alternative embodiment, the weatherability of a cured coating may be assessed by monitoring changes in the appearance or color of a coated substrate over time. For example, the cured coating described herein may be tested by accelerated weathering procedures known in the art. In an aspect, a weatherable coating as described herein is a coating that demonstrates only a small change in color on accelerated weathering testing over a period of time equivalent to about 4 years of exposure, or about 1000 MJ of radiation.

Conventionally, two types of color systems are used to visually observe and assess color changes in pigments included in a coating composition. The color systems have at least three dimensions, in order to include all possible colors, and can be based either on a specific arrangement of predetermined colors, or by identifying colors mathematically. The mathematical color system is the Hunter color system and is based on mathematical description of the light source, objects and a standard observer. The light reflected or transmitted by an object is measured with a spectrophotometer or similar apparatus or instrument. The data can be mathematically reproduced as three-dimensional CIE color space. Color differences (ΔE) are calculated using the L a b equations, where L represents lightness, a represents redness-greenness and b represents yellowness-blueness. The quantities on the L a b scale are calculated using equations known in the art.

Accordingly, in an embodiment, a cured coating as described herein is considered weatherable if it demonstrates only a small change in color after prolonged exterior exposure. In an aspect, the color change (ΔE) is denoted by a color shift that is easily observed by visual or instrumental means, such as with the eye, or with a spectrophotometer, for example. The color shift corresponds to a particular number of units on at least one axis of the L a b scale. In an aspect, for a cured coating to be weatherable, the color change (ΔE) is less than 2, preferably less than 1.5, more preferably less than 1.

In addition to durability and weatherability, the cured coating described herein may also demonstrate other useful performance characteristics such as, for example, pencil hardness, flexibility, and the like.

The coating composition has utility in a multitude of applications. The coating composition of the invention may be applied, for example, as an intermediate coat, as a topcoat, or any combination thereof. The coating composition may be applied to sheet metal such as is used for lighting fixtures, architectural metal skins (e.g., gutter stock, window blinds, siding and window frames and the like) by spraying, dipping, or brushing, but is particularly suited for a coil coating operation where the composition is applied onto the sheet as it unwinds from a coil and then baked as the sheet travels toward an uptake coil winder. It is further contemplated that the coating composition of the invention may have utility in a variety of other end uses, including, industrial coating applications such as, e.g., appliance coatings; packaging coating applications; interior or exterior steel building products; HVAC applications; agricultural metal products; wood coatings; etc. In a preferred aspect, the cured coating described herein is used as an exterior coating for building materials, architectural skins and the like.

Non-limiting examples of metal substrates that may benefit from having a coating composition of the invention applied on a surface thereof include hot-rolled steel, cold-rolled steel, hot-dip galvanized, electro-galvanized, aluminum, tin plate, various grades of stainless steel, and aluminum-zinc alloy coated sheet steel (e.g., GALVALUME sheet steel).

The coating is typically cured or hardened in a heated temperature environment of from about 200 to 500° C., more preferably from about 270 to 470° C. For coil coating operations, the coating is typically baked for 8 to 25 seconds, to a peak metal temperature (PMT) of from about 200 to 250° C.

### Test Methods

Unless indicated otherwise, the following test methods were utilized in the Examples that follow.

### Accelerated Weathering Test

Coating compositions with various different pigments or colors are applied to 0.019-inch (0.0483 cm) thick metal test panels previously treated with BONDERITE 1455SF pretreatment (Henkel), BONDERITE 1402W (Henkel), zinc phosphate, or the like by standard methods known in the art at a dry film thickness (dft) of about 0.7 mil (approximately 17-18 micron). The test panels are placed in an electric oven to give panels baked at a peak metal temperature of 232° C. (450° F.). The test panels are then subjected to accelerated weathering using the QUV-A method (Q-Lab, Florida), where panels are exposed to 340-nm peak irradiance uv radiation, or the Q-TRAC system, where panels are exposed to concentrated natural sunlight, to simulate natural weather conditions (Q-Lab, Florida). In QUV-A testing, test panels are exposed to alternating cycles of UV light and moisture at controlled, elevated temperatures for various periods of time, from 250 hours up to about 1500 hours. The test simulates the effects of sunlight using special fluorescent UV lamps. Also, the QUV-A testing process simulates the effect of dew and rain over a prolonged time period with condensing humidity and/or water spray. In Q-Trac testing, test panels are exposed to concentrated sunlight using an array of ten mirrors that reflects and concentrates sunlight onto the panels. Using this arrangement, the panels, mounted opposite the mirrors, are subjected to five times the radiation typically experienced in southern Florida. In this test, an exposure of about 250 MJ at a 45° exposure angle is considered equivalent to 12 months of direct sunlight exposure in southern Florida (assuming constant temperature and weather conditions over the test period). For both tests, the color (L, a, b-values) for each panel are measured over a period of time equivalent to about 1500 hours of exposure (QUV-A) or five years of exposure (Q-Trac), and weatherability is assessed according to the AE value obtained for each panel.

### Gloss Test

Cured coatings as described herein were tested for surface gloss according to ASTM D523 (Standard Test Method for Specular Gloss). Panels are prepared according to standard methods known in the art and gloss ratings are taken at a 60° angle using a handheld gloss meter (Byk Gardner USA, Maryland). These gloss ratings are compared to the ratings from a black glass standard at the same angle. A durable and weatherable coating will demonstrate minimal change in gloss over a short period of exposure to natural sunlight

### EXAMPLES

The present invention is illustrated by the following examples. It is to be understood that the particular examples, materials, amounts, and procedures are to be interpreted broadly in accordance with the scope and spirit of the invention as set forth herein. Unless otherwise indicated, all parts and percentages are by weight and all molecular weights are weight average molecular weight. Unless otherwise specified, all chemicals used are commercially available from, for example, Sigma-Aldrich, St. Louis, Mo.

### Example 1

### Preparation of Coating Compositions

Coating compositions (#1 through #17) were prepared by combining 25 to 25 wt % of a commercially available durable polyester resin with 35 to 70 wt % of (a) a commercially available siliconized polyester (comparative), or (b) the siliconized polyester as described herein (inventive), along with 12 to 20 wt % of a melamine curing agent. The resins and crosslinking agent were blended together using standard mixing techniques known in the art, along with minimum levels of flow agents to facilitate air release during the coil coating process. About 2 to 5 wt % of a blocked acid catalyst was incorporated, along with flatting agent to provide a gloss rating between 35 and 40 when measured at a 60° angle with a handheld gloss meter (Byk Gardener). The coating compositions were combined with one or more pigments with the colors or shades approved by the Cool Roof Rating Council (CRRC), as shown in Table 1. Coating compositions were also prepared using a commercially available PVDF-based coil coating system and/or a commercially available durable polyester resin. The coating compositions were applied to metal panels using standard application methods, and baked at peak metal temperatures of about 200° to 250° C.

TABLE 1
Coating Compositions

| Coating | Color |
|---|---|
| 1 | Burgundy |
| 2 | Red |
| 3 | Crimson Red |
| 4 | Hawaiian Blue |
| 5 | Cocoa Brown |
| 6 | Colony Green |
| 7 | H/G White |
| 8 | Quaker Gray |
| 9 | Silver Sparkle |
| 10 | Light Stone |
| 11 | Timber Tan |
| 12 | Blue |
| 13 | Taupe |
| 14 | Evergreen |
| 15 | USDA White |
| 16 | Ash Gray |
| 17 | Matte Black |

### Example 2

### Performance Testing

### Accelerated Weathering Test (Q-Trac)

The coating compositions of Example 1 were applied to test panels, baked, and subjected to accelerated weathering testing according to the Q-Trac method at a 45° exposure angle. The change in color (ΔE, determined from the observed ΔL, Δa and Δb values) of the coating over various amounts of sunlight exposure (equivalent to exposure from 6 months to about five years) was determined and compared with the change in color for standard PVDF or durable polyester coatings tested under the same conditions. Gloss retention over the same period of time was also determined and compared with standard coatings tested under the same conditions. Results for the coatings from Table 1 are shown in Table 2 and Table 3.

TABLE 2
Change in Coating Color After 1400 MJ Sunlight Exposure

| | ΔE after 1400 MJ Q-Trac Exposure | | | | | | | | | | | | | |
|---|---|---|---|---|---|---|---|---|---|---|---|---|---|---|
| Coating | 1 | 3 | 4 | 5 | 6 | 7 | 10 | 11 | 12 | 13 | 14 | 15 | 16 | 17 |
| Inventive | 1.06 | 0.83 | 0.25 | 0.24 | 0.11 | 0.36 | 0.17 | 0.31 | 0.22 | 0.11 | 0.73 | 0.6 | 0.22 | 0.11 |
| Comparative | 1.06 | 2.85 | 0.3 | 0.63 | 0.35 | 0.22 | 0.36 | 0.38 | 0.34 | 0.32 | 0.86 | 0.16 | 0.3 | — |
| PVDF | 0.23 | 2.85 | 0.16 | 0.37 | — | — | 0.12 | 0.1 | — | — | 0.73 | — | 0.11 | — |
| Polyester | 1.21 | 1.34 | 0.36 | 0.69 | 0.23 | 0.26 | 0.24 | 0.28 | 0.24 | 0.19 | 1.01 | 0.27 | 0.31 | 0.79 |

TABLE 3
Gloss Retention After 1400 MJ Sunlight Exposure

| | Gloss Retention (%) After 1400 MJ Q-Trac Exposure | | | | | | | | | | | | | | |
|---|---|---|---|---|---|---|---|---|---|---|---|---|---|---|---|
| Coating | 1 | 2 | 3 | 4 | 5 | 6 | 7 | 10 | 11 | 12 | 13 | 14 | 15 | 16 | 17 |
| Inventive | 19 | 38 | 32 | 31 | 24 | 24 | 82 | 60 | 39 | 30 | 38 | 41 | 84 | 63 | 27 |
| Comparative | 19 | 38 | 30 | 23 | 27 | 29 | 77 | 55 | 34 | 17 | 29 | 48 | 59 | 28 | — |
| PVDF | 84 | 94 | 65 | 78 | 75 | — | — | 94 | 94 | — | — | 57 | — | 95 | — |
| Polyester | 23 | 48 | 42 | 31 | 36 | 32 | 96 | 55 | 47 | 45 | 41 | 48 | 77 | 45 | 26 |

### Accelerated Weathering Test (QUV-A)

The coating compositions of Example 1 were applied to test panels, baked, and subjected to accelerated weathering testing according to the QUV-A method for various periods of time equivalent to from about 250 hours of exposure to about 1000 hours of exposure. The change in color (ΔE, determined from the observed ΔL, Δa and Δb values) of the inventive and comparative coatings was determined at 1000 of exposure and compared with the change in color for standard PVDF or durable polyester coatings tested under the same conditions. Similarly, gloss retention over 1000 hours of exposure for the inventive and comparative coatings was determined and compared to gloss retention for standard PVDF or durable polyester coatings tested under the same conditions. Results are shown in Table 4 and Table 5.

TABLE 4
Change in Coating Color After 1000 Hours UV Exposure

| | ΔE after 1000 Hours QUV-A Exposure | | | | | | | | | | | | | | |
|---|---|---|---|---|---|---|---|---|---|---|---|---|---|---|---|
| Coating | 1 | 2 | 3 | 4 | 5 | 6 | 7 | 10 | 11 | 12 | 13 | 14 | 15 | 16 | 17 |
| Inventive | 0.41 | 0.25 | 0.14 | 0.91 | 0.09 | 0.42 | 0.22 | 0.35 | 0.42 | 0.17 | 0.21 | 0.98 | 0.28 | 0.32 | 0.43 |
| Comparative | 0.6 | 0.67 | 0.34 | 0.37 | 0.33 | 0.11 | 0.87 | 0.13 | 0.11 | 0.3 | 0.21 | 0.08 | 0.17 | 0.17 | — |
| PVDF | 0.07 | 0.18 | 0.78 | 0.08 | 0.15 | — | — | 0.14 | — | — | — | 0.61 | — | 0.18 | — |
| Polyester | 0.35 | 0.15 | 0.38 | 0.07 | 0.1 | 0.03 | 0.65 | 0.19 | 0.25 | 0.36 | 0.09 | 0.43 | 0.31 | 0.38 | 0.13 |

TABLE 5
Gloss Retention After 1000 Hours UV Exposure

| | Gloss Retention (%) After 1000 Hours QUV-A Exposure | | | | | | | | | | | | | | |
|---|---|---|---|---|---|---|---|---|---|---|---|---|---|---|---|
| Coating | 1 | 2 | 3 | 4 | 5 | 6 | 7 | 10 | 11 | 12 | 13 | 14 | 15 | 16 | 17 |
| Inventive | 118 | 142 | 80 | 90 | 139 | 127 | 134 | 138 | 105 | 105 | 157 | 93 | 115 | 78 | 175 |
| Comparative | 111 | 128 | 87 | 89 | 97 | 100 | 93 | 81 | 114 | 91 | 94 | 107 | 97 | 80 | — |
| PVDF | 100 | 104 | 80 | 100 | 97 | — | — | 83 | — | — | — | 90 | — | 101 | — |
| Polyester | 114 | 120 | 95 | 108 | 106 | 113 | 95 | 121 | 124 | 118 | 117 | 109 | 120 | 140 | 107 |

As indicated by the data in Tables 2-5, cured coatings as described herein demonstrate weatherability and gloss retention comparable, and in some cases, superior to industry standard exterior coil coatings and commercial cured coatings that include conventional siliconized polyester resin.

Having thus described the preferred embodiments of the present invention, those of skill in the art will readily appreciate that the teachings found herein may be applied to yet other embodiments within the scope of the claims hereto attached. The complete disclosure of all patents, patent documents, and publications are incorporated herein by reference as if individually incorporated.

What is claimed is:

1. A cured coating formed from a thermosetting coating composition, the composition comprising:
a binder system including:
a first polyester resin; and
a second polyester resin having up to about 30% silicone content, based on the total weight of the first and second polyester resins;
about 5 to 15 wt % crosslinking agent;
about 0.1 to 2 wt % catalyst; and
about 0.01 to 0.5 wt % flow agent,
wherein the cured coating is a weatherable exterior coating having a 60° gloss rating of about 5 to 90, and demonstrating a change in color (4E) of less than one unit after at least about 1000 MJ of exposure to direct sunlight.

2. The coating of claim 1, wherein the second resin has molecular weight (Mₙ) of less than about 10,000 amu, and a Mw of less than about 15,000.

3. The coating of claim 1, wherein the second resin has a hydroxyl number of at least 75.

4. The coating of claim 1, wherein the second resin is a silicone-modified polyester.

5. The coating of claim 1, wherein the second resin is a silicone-modified polyester made by a method comprising:
providing a polyol prepared by co-condensation of at least one alcohol with at least one silanol; and
esterifying the polyol by reaction with at least one acid-functional compound, wherein the reaction is carried out in the presence of a titanium-based catalyst.

6. The coating of claim 1, wherein the first resin is a durable polyester resin.

7. The coating of claim 1, wherein the crosslinking agent is an aminoplast resin crosslinker.

8. The coating of claim 1, wherein the crosslinking agent is a melamine cure additive.

9. The coating of claim 1, wherein the catalyst is an acid catalyst.

10. The coating of claim 1, wherein the catalyst is blocked p-toluene sulfonic acid.

11. The coating of claim 1, wherein the catalyst is non-blocked p-toluene sulfonic acid.

12. The coating of claim 1, wherein the composition further comprises a pigment.

13. The coating of claim 1, wherein the composition further comprises a pigment is dispersed in the second polyester resin.

14. The coating of claim 1, wherein the composition further comprises a pigment dispersed in the first polyester resin.

15. The coating of claim 1, wherein the composition further comprises a pigment dispersed in a blending polyester resin.

16. The coating of claim 1, wherein the composition further comprises a pigment dispersed in the crosslinking agent.

17. The coating of claim 1, wherein the composition further comprises about 6% to 10% of a blend of polar solvents, based on the total weight of the composition.

18. The coating of claim 1, wherein the composition further comprises about 6% to 10% of one or more flatting agents, based on the total weight of resin solids in the composition.

19. The coating of claim 1, wherein the composition further comprises about 3% to 10% of one or more waxes, based on the total weight of resin solids in the composition.
